(19) United States
(12) Patent Application Publication
(10) Pub. No.: US 2005/0023887 A1
(43) Pub. Date: Feb. 3, 2005

(54) Vacuum actuated brake pressure intensifier

(75) Inventors: Gary C. Fulks, Dayton, OH (US); Timothy A. Haerr, Enon, OH (US); Douglas E. Poole, Dayton, OH (US)

Correspondence Address: SCOTT A. MCBAIN;DELPHI TECHNOLOGIES, INC., P.O. Box 5052, Mail Code: 480-410-202, Troy, MI, 48007, US

(73) Assignee: DELPHI TECHNOLOGIES INC.

(21) Appl. No.: 10/629,305

(22) Filed: Jul. 29, 2003

(51) Int. Cl. B60T 13/46

(52) U.S. Cl. 303/4

(57) ABSTRACT

A power brake apparatus includes a hydraulic pressure intensifier apparatus, having a hydraulic pressure intensifier controlled by a vacuum powered actuator. The hydraulic pressure intensifier defines a circuit for hydraulic fluid having an intensifier inlet for receiving hydraulic fluid from a master cylinder of the power brake apparatus at a master cylinder pressure, and an intensifier outlet for selectively delivering hydraulic pressure to a braking device at either the master cylinder pressure or at an intensified pressure higher than the master cylinder pressure. The vacuum powered actuator selectively controls the hydraulic pressure intensifier to deliver hydraulic fluid at the intensifier outlet at the master cylinder pressure when vacuum is available for providing power braking and at the intensified hydraulic pressure when vacuum is not available.

### TECHNICAL FIELD OF THE INVENTION

This invention relates to vehicle brakes, and more particularly to a vehicle with a hydraulic brake apparatus including both a vacuum booster for providing power assisted braking, and a hydraulic brake booster that increases braking pressure when the vacuum booster is not operating.

### BACKGROUND OF THE INVENTION

Since the mid 1930s, vehicles such as automobiles and light trucks have predominantly utilized hydraulic brake systems having a pedal operated master cylinder supplying pressurized hydraulic fluid to disk or drum braking devices at each wheel.

Early hydraulic brake systems utilized a single hydraulic fluid circuit supplying pressurized fluid from the master cylinder to all four corners of the vehicle. A break in the fluid circuit anywhere rendered the entire hydraulic brake system inoperative.

In order to prevent a total loss of hydraulic braking in the event of a failure of part of the system, failsafe hydraulic split brake systems were developed that provided two separate fluid circuits from the master cylinder, configured such that a failure of either of the two fluid circuits would still leave hydraulic brakes operative on at least two corners of the vehicle. In rear wheel drive automobiles and light trucks, one fluid circuit typically served the front wheels, and the other fluid circuit served the rear wheels, to provide a front/rear (F/R) failsafe hydraulic split system. Front wheel drive vehicles typically used a diagonal failsafe hydraulic split system, having one front corner and the diagonally opposite rear corner of the vehicle on one fluid circuit, and the other front corner and its diagonally opposite rear corner on the second fluid circuit. These failsafe provisions were incorporated into government regulations that required brake systems to be configured such that a single failure of the braking system would still leave the brakes on at least two corners of the vehicle operational.

In the years since hydraulic brake systems became the norm, many additional features have been added to further enhance safe operation and optimize vehicle performance. Modern brake systems often include a booster that amplifies force exerted on the brake pedal, to provide power brakes that allow a person operating the vehicle to control the brakes with significantly less force on the brake pedal than is required in a non-boosted brake system. Such boosted systems are typically known as power brake systems, or power-assisted brake systems.

FIG. 1 shows a typical power brake system 18. When the driver steps on a brake pedal 20, a pushrod 22 attached to the pedal 20 moves to the right, as illustrated in FIG. 1, and applies an input force to one or more pistons (not shown) located inside of a master cylinder 24. The input force applied to the master cylinder piston(s) is considerably greater than the force applied to the brake pedal, due to the leverage provided by the length of the brake pedal, the manner in which the push rod is attached to the brake pedal, and the manner in which the brake pedal is pivoted from the vehicle frame.

The input force causes the piston(s) in the master cylinder 24 to generate a master cylinder pressure in a first brake line 40 connected to a first pair of wheel cylinders 44, 46, and in a second brake line 42 connected to a second pair of wheel cylinders 48, 50. The first and second pairs of wheel cylinders 44, 46, 48, 50 can be connected respectively to the front and rear wheels, or diagonally to one front and the opposite rear wheel, in the manner described above, depending upon the type of vehicle in which the brake system 18 is installed.

The pushrod 22 extends through a vacuum booster 26 that includes a diaphragm 28, having a large area, connected to the pushrod 22. The diaphragm separates and seals a forward fluid chamber 38 of the booster 26 from a rear fluid chamber 36 of the booster. The forward fluid chamber 38 is connected to the vehicle vacuum system 30, and the rear fluid chamber 36 is vented to atmosphere via a port 32. As the driver pushes on the brake pedal 20, the pushrod operates a control valve (not shown) in the booster, in a manner known in the art, to open the forward chamber 38 to the vacuum system 30. As the vacuum system 30 evacuates the forward chamber 38, atmospheric air pressure in the rear chamber 36 acting against the diaphragm area provides an additive force that substantially increases the input force applied to the master cylinder 20 by the push rod 22, in comparison to the force exerted on the push rod 22 by the brake pedal 20. The booster 26 substantially augments the force applied to brake pedal 20 by the driver in a manner that causes the master cylinder 24 to provide substantially higher pressure to the brake lines 40, 42. Braking force is thus considerably increased while keeping the force that the driver must apply to the pedal 20 at a modest value.

For proper braking to be achieved, the master cylinder 26 must displace a volume of hydraulic fluid in each the brake lines 40, 42 and generate sufficient brake pressure to operate a pair of wheel cylinders in a manner that will stop the vehicle in a reasonable distance with an acceptable amount of travel of the brake pedal 20. Typically it is necessary for the master cylinder to produce brake pressures in the range of 100-2000 PSI to provide proper braking of the vehicle under all operating conditions that the vehicle might encounter. A typical vacuum booster 26 increases master cylinder by a boost ratio in a range of about 6:1 to 8:1. With a boost ratio of 7:1 the driver need only exert a force on the brake pedal that is large enough, in and of itself, to produce a brake pressure of 250 PSI, in order to achieve a boosted brake pressure of 1750 PSI.

If the booster 26 or vacuum system 30 should fail, however, or if the driver attempts to apply the brakes when the engine is not running, the power braking function normally provided by the booster 26 will not be available for boosting the input force applied to the master cylinder 24 by the push rod 22. A substantial loss of brake pressure at normal pedal inputs will be experienced, and the driver may not be able to exert sufficient additional force on the brake pedal 20 to stop the vehicle within a desirable stopping distance.

It is desirable that a power brake apparatus provide some means of at least partially compensating for the loss of master cylinder pressure and braking pressure when the brake booster 26 is not operating, so that the driver can still maintain adequate braking control of the vehicle by exerting a reasonable amount of additional force on the brake pedal 20.

Commonly assigned U.S. Pat. No. 6,547,048 B2, titled Manual Braking System with Hydraulic Brake Booster, by Haerr, et al, provides a power braking system that includes a hydraulic brake booster, in addition to a vacuum brake booster, to intensify the master cylinder pressure in the event that the vacuum booster should become inoperative. As shown in FIG. 2, a hydraulic brake booster 60 according to Haerr '048 is inserted into one or both of the brake lines 40, 42 of a vehicle braking system 18 between the master cylinder 24 and the wheel cylinders 44, 46, 48, 50. The hydraulic brake booster 60 includes a hydraulic intensifier 66, a bypass valve 64, and a pressure/vacuum sensor 62.

The hydraulic intensifier 66 of Haerr '048 includes an intensifier inlet 61 connected to the brake line 40 for receiving pressurized fluid from the master cylinder 24, and an intensifier outlet 63 connected to the wheel cylinders 44, 46. The bypass valve 64 is a controllable valve, such as an electrically operated solenoid valve, connected in a parallel fluid circuit relationship with the hydraulic intensifier 66, to provide a bypass flow path around the hydraulic intensifier 66 when the bypass valve 64 is open, and to block flow in either direction around the hydraulic intensifier 66 when the bypass valve 64 is closed. The pressure/vacuum sensor 62 is operatively connected between the source of vacuum 30, or the front chamber 38 of a vacuum booster 26, and the bypass valve 64, for controlling the bypass valve 64 in such a manner that the bypass valve 64 is held open when the pressure/vacuum sensor 62 detects a vacuum, and is held closed when the pressure/vacuum sensor 62 does not detect a vacuum.

The hydraulic intensifier 66 of Haerr '048 includes a stepped bore 65, enclosing a stepped piston 67. The stepped piston 67 has a larger end 68 exposed to master cylinder pressure at the intensifier inlet 61, and a smaller end 69 exposed to brake pressure at the intensifier outlet 63. When the pressure/vacuum sensor 62 detects a vacuum, the bypass valve 64 is opened to provide fluid at boosted master cylinder pressure to the wheel cylinders 44, 46 through the bypass valve 64, and the hydraulic intensifier 66 is inactive. When the pressure/vacuum sensor 62 detects an abnormal vacuum condition, the bypass valve 64 is closed to apply fluid at un-boosted master cylinder pressure to the larger end 68 of the stepped piston 67 of the hydraulic intensifier 66.

The pressure applied to the larger end 68 of the stepped piston 67, in the hydraulic intensifier 66, generates a force at the smaller end 69 of the stepped piston 67 that acts against the fluid trapped between the smaller end 69 of the piston 67 and the wheel cylinders 44, 46 when the bypass valve 64 is held closed in accordance with the signal provided by the pressure/vacuum sensor 62. By virtue of the difference in area between the larger and smaller ends 68, 69 of the stepped piston 67, the pressure generated at the smaller end 69 by the un-boosted master cylinder pressure acting on the larger end 68 of the piston 67 is greater than the un-boosted master cylinder pressure, according to the principles of hydraulics.

The increase in brake pressure provided by the hydraulic intensifier 66 is directly proportional to the ratio of the area of the large and small ends 68, 69 of the stepped piston 67. Where the larger end 68 of the stepped piston 67 has an area approximately twice as large as the area of the smaller end 69, for example, the un-boosted master cylinder pressure applied to the intensifier inlet 61 will be approximately doubled at the intensifier outlet 63.

Somewhat more pedal travel will be required when the hydraulic intensifier 66 is operating, however, due to the fact that the master cylinder 24 must supply an additional volume of fluid for filling the larger end of the cylinder bore 65 of the hydraulic intensifier 66 in the area adjacent the larger end 68 of the stepped piston 67. Although drivers will likely notice the additional pedal travel, they will still be able to achieve nearly normal braking of the vehicle by applying an acceptable additional amount of force to the brake pedal, over and above the amount of pedal force that they are accustomed to applying when the vacuum booster 26 is operating.

Although a power braking system 18 practicing the teachings of Haerr '048, provides considerable improvement over prior power braking systems in addressing the problem of operation without vacuum boost, it is desirable in some vehicles to provide braking operation without vacuum boost in a manner that does not require the pressure/vacuum switch 62 or an electrically controlled bypass valve 64 of Haerr '048.

### SUMMARY OF THE INVENTION

Our invention provides an improved power brake apparatus, meeting the requirements discussed above, through use of a hydraulic-pressure intensifier apparatus, that includes a hydraulic pressure intensifier controlled by a vacuum powered actuator. The hydraulic pressure intensifier defines a circuit for hydraulic fluid having an intensifier inlet for receiving hydraulic fluid from a master cylinder of the power brake apparatus at a master cylinder pressure, and an intensifier outlet for selectively delivering hydraulic pressure to a braking device at either the master cylinder pressure or at an intensified pressure higher than the master cylinder pressure. The vacuum powered actuator selectively controls the hydraulic pressure intensifier to deliver hydraulic fluid to the intensifier outlet at the master cylinder pressure when vacuum is available for providing power braking and at the intensified hydraulic pressure when vacuum is not available.

The hydraulic pressure intensifier may also include a mechanically actuated outlet valve apparatus for allowing a flow of hydraulic fluid between the intensifier inlet and the intensifier outlet when the vacuum powered actuator is controlling the intensifier to provide hydraulic fluid to the intensifier outlet at the first pressure, and to block a flow of hydraulic fluid between the intensifier inlet and outlet when the vacuum powered actuator is controlling the intensifier to provide hydraulic fluid to the intensifier outlet at the second pressure. The outlet valve apparatus may be further configured for allowing a flow of hydraulic fluid from the intensifier inlet and intensifier outlet while the vacuum powered actuator is controlling the intensifier to provide hydraulic fluid to the intensifier outlet at the second pressure, when the pressure at the intensifier outlet is less than the pressure at the intensifier inlet.

Our invention may also take the form of a method for operating a power braking apparatus including hydraulic pressure intensifier apparatus of the type described herein.

The foregoing and other features and advantages of our invention will become further apparent from the following detailed description of exemplary embodiments, read in conjunction with the accompanying drawings. The detailed description and drawings are merely illustrative of our invention rather than limiting, the scope of the invention being defined by the appended claims and equivalents thereof.

### BRIEF DESCRIPTION OF THE DRAWINGS

FIG. 1 is a schematic representation of a prior power brake system;

FIG. 2 is a schematic of a prior power braking system, according to commonly assigned patent U.S. Pat. No. 6,547,048 B2, to Haerr, et al, having a hydraulic brake booster;

FIG. 3 is a schematic representation of a power brake apparatus, according to the present invention, including a cross sectional view of an exemplary embodiment of a vacuum powered hydraulic intensifier apparatus according to the present invention;

FIG. 4 is an enlarged cross sectional view of a hydraulic pressure intensifier of the hydraulic pressure intensifier apparatus of FIG. 3;

FIG. 5 is a top view of the hydraulic pressure intensifier apparatus of FIG. 3, showing an internal bypass passage of the hydraulic pressure intensifier apparatus;

FIGS. 6a and 6b are cross sectional views of a vacuum powered actuator of the hydraulic pressure intensifier apparatus of FIG. 3, respectively showing the actuator with, and without, vacuum applied to the actuator;

FIGS. 7a-d show an alternate exemplary embodiments of a vacuum powered actuator, according to the present invention; and

FIG. 8 shows an alternate exemplary embodiment of a mechanically actuated outlet valve apparatus in a hydraulic pressure intensifier apparatus, according to the present invention.

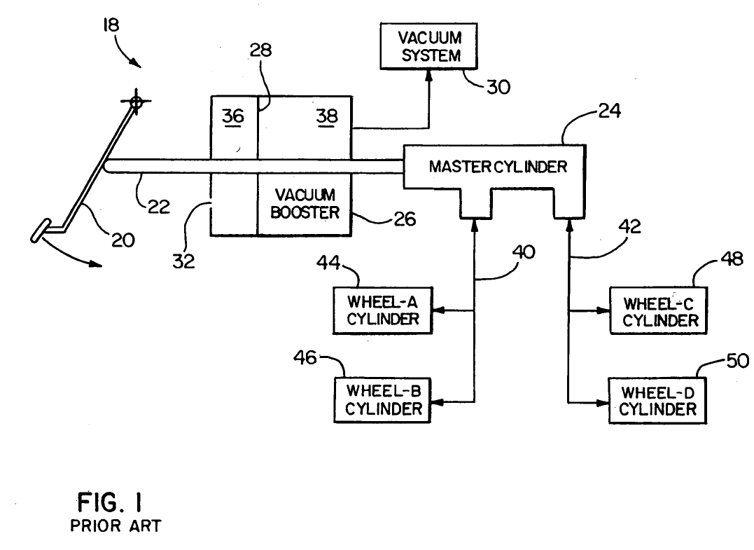

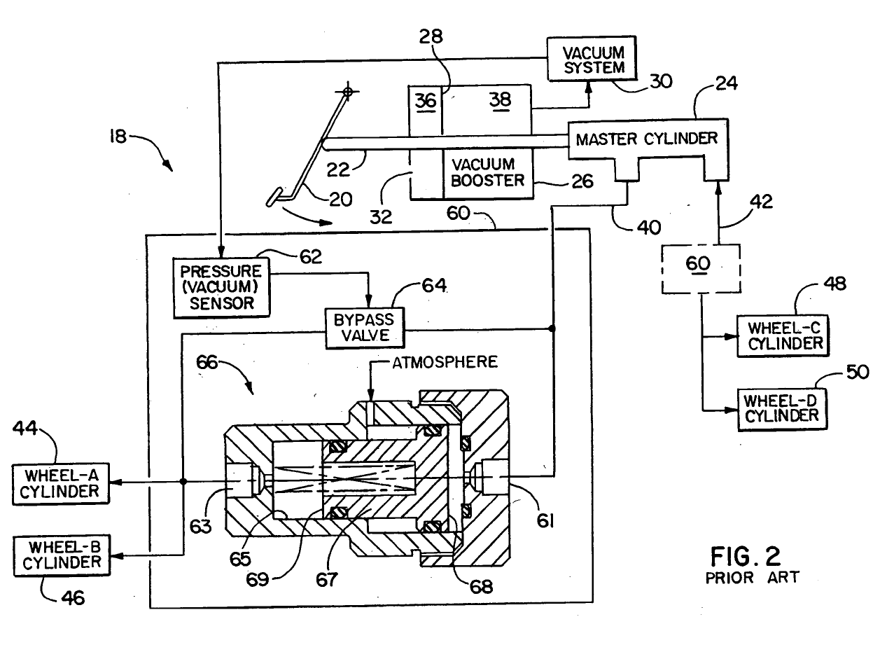

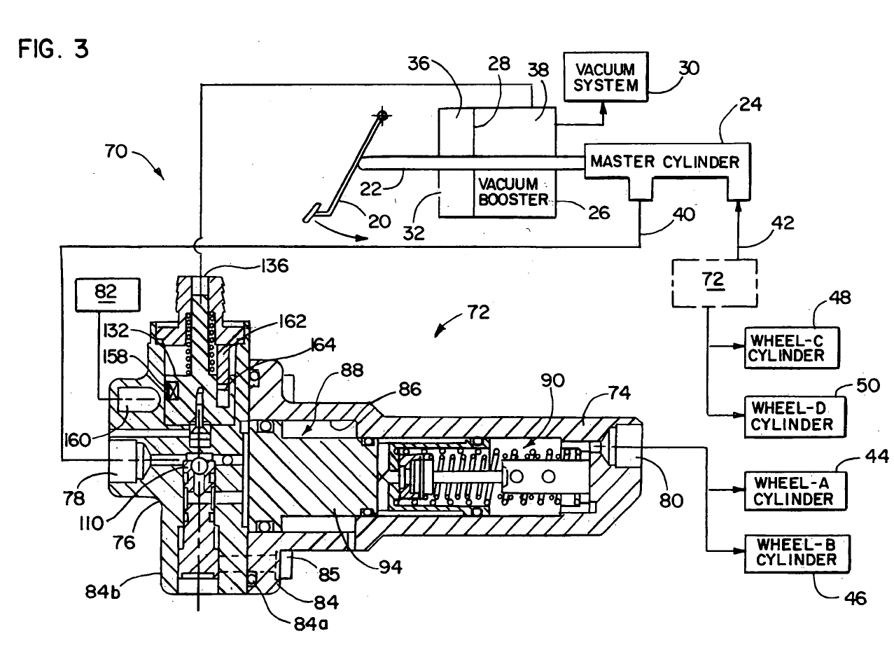

To facilitate understanding of our invention, and the distinctions between our invention and prior brake systems, the components in FIGS. 3-8 that are substantially equivalent or similar to the components described above, in relation to FIGS. 1 and 2, will be given the same reference numbers used in the FIGS. 1 and 2.

Throughout the following description of exemplary embodiments of our invention, components and features that are substantially equivalent or similar will be identified in the drawings by the same reference numerals. For the sake of brevity, once a particular element or function of our invention has been described in relation to one exemplary embodiment, the description and function will not be repeated for elements that are substantially equivalent or similar in form and/or function to the components previously described, in those instances where the alternate exemplary embodiments will be readily understood by those skilled in the art from a comparison of the drawings showing the various exemplary embodiments in light of the description of a previously presented embodiment.

### DETAILED DESCRIPTION

FIG. 3 shows a first exemplary form of a brake apparatus 70, including a vacuum powered hydraulic pressure intensifier apparatus 72, according to our invention. The embodiment depicted in FIG. 3 includes many of the same components that are used in the prior braking systems 18 discussed above with regard to FIGS. 1 and 2.

The exemplary embodiment of the brake apparatus 70 depicted in FIG. 3 includes four braking devices in the form of four wheel cylinders 44, 46, 48, 50. A master cylinder 24 supplies pressurized fluid at a master cylinder pressure brake lines 40, 42 to the braking devices 44, 46, 48, 50 in response to an input force applied to the master cylinder 24. The input force is applied to the master cylinder 24 by a push rod 22, connected to a brake pedal 20 and the diaphragm 28 of a vacuum booster 26. The vacuum booster 26 includes a front chamber 38 that is selectively connected to a vacuum source 30 by a control valve (not shown) within the booster 26 that is actuated when pressure is applied to the brake pedal 20, and a rear chamber 36 that is continuously vented to the atmosphere by a vent 32.

The brake apparatus 70 is a split brake system including a vacuum actuated hydraulic pressure intensifier apparatus 72. The following description is limited to the vacuum actuated hydraulic pressure intensifier apparatus 72 in the first brake line 40, but could also apply to a second vacuum actuated hydraulic pressure intensifier apparatus 72, according to our invention, located in the second brake line 42.

The vacuum actuated hydraulic pressure intensifier apparatus 72 includes a hydraulic pressure intensifier 74 and a vacuum powered actuator 76.

The hydraulic pressure intensifier 74 defines a circuit for hydraulic fluid, described in more detail below, having an intensifier inlet 78 for receiving hydraulic fluid from the master cylinder 26 at the master cylinder pressure, and an intensifier outlet 80 for selectively delivering hydraulic pressure to the braking devices 44, 46, at either the master cylinder pressure or at a second, intensified pressure higher than the master cylinder pressure. The vacuum powered actuator 76 selectively controls the hydraulic pressure intensifier 74, in a manner described in more detail below, to provide hydraulic fluid to the intensifier outlet 80 at the master cylinder pressure, or at the intensified hydraulic pressure.

The brake apparatus 70 also includes a latching annunciation element 82 for detecting when the vacuum powered actuator 76 is controlling the hydraulic pressure intensifier 74 to supply fluid at the second, intensified pressure, and sending a signal to an on-board computer or to a warning light.

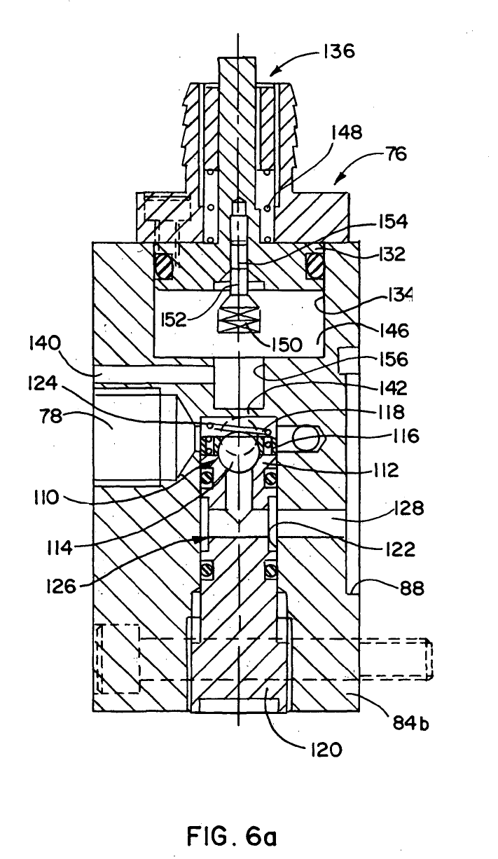

The hydraulic pressure intensifier apparatus 72 includes a two-part housing 84, having an intensifier housing 84a and an actuator housing 84b attached to one another by screws 85. As shown, in FIGS. 3-5, the housing 84 defines the intensifier inlet and outlet 78, 80, and a stepped intensifier cylinder bore 86, having a larger end 88 and a smaller end 90. The intensifier inlet 78 is connected in fluid communication with the larger end 88 of the intensifier cylinder bore 86, and the intensifier outlet 80 is connected in fluid communication with the smaller end 90 of the intensifier cylinder bore 86. The housing 84 further defines an intensifier internal fluid bypass passage 92, as shown in FIG. 5, providing fluid communication between the intensifier inlet 78 and the smaller end 90 of the intensifier cylinder bore 86.

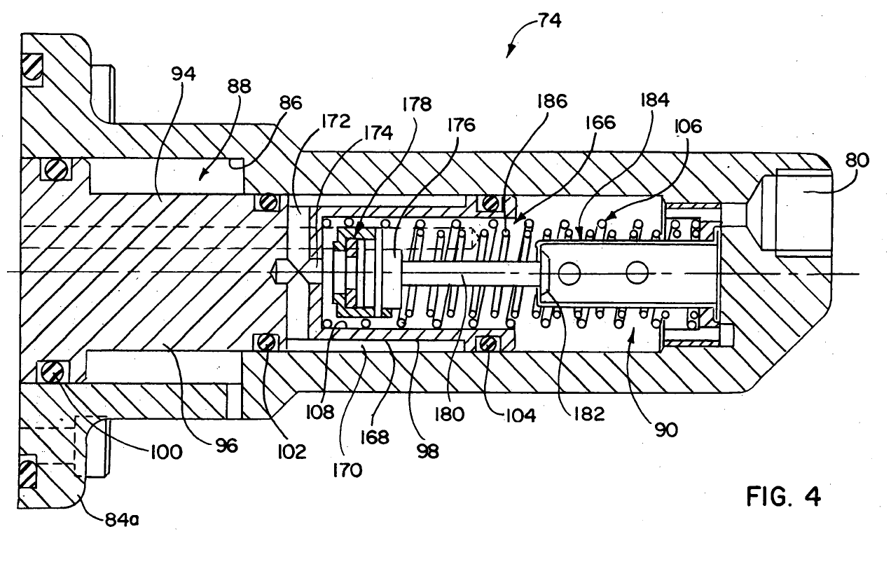

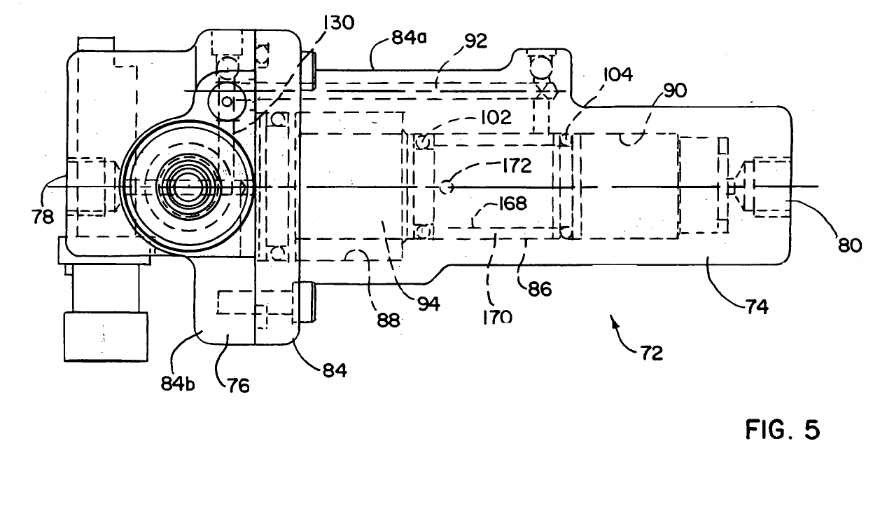

As shown, in FIGS. 3 and 4, an intensifier piston 94 having a larger end 96 and a smaller end 98 thereof, is disposed within the intensifier bore 86. The larger end 96 of the intensifier piston 94 is disposed within and slidingly sealed with a first intensifier piston seal 100 to the larger end 88 of the intensifier cylinder bore 86. The smaller end 98 of the intensifier piston 94 is disposed within and slidingly sealed by axially spaced second and third intensifier piston seals 102, 104 to the smaller end 90 of the cylinder bore 86.

An intensifier piston return spring 106, in the form of a helical compression spring, is disposed within the smaller end 90 of the intensifier piston cylinder bore 86, between the intensifier piston 94 and the housing 84 for urging the intensifier piston 94 to move within the intensifier cylinder bore 86 toward the larger end 88 of the intensifier cylinder bore 86. The smaller end 98 of the intensifier piston 94 includes a cylindrical recess 108, opening toward the intensifier outlet 80, for receiving one end of the intensifier piston return spring 106. The recess 108 allows a longer intensifier piston return spring 106 to be used, for improved performance of the intensifier. In some embodiments of our invention, the recess 108 also accommodates a mechanically actuated outlet valve apparatus 166 described in more detail below.

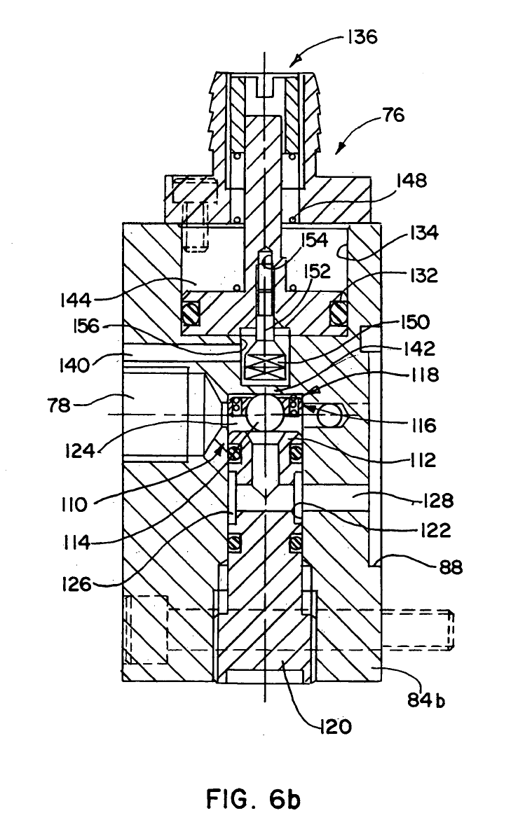

As shown in FIGS. 3, and 6a-b, an intensifier inlet valve 110, operatively actuated by the vacuum powered actuator 76 in a manner described in greater detail below, selectively directs hydraulic fluid from the intensifier inlet 78 to either the larger end 88 of the intensifier cylinder bore 86, or alternatively through the intensifier internal bypass passage 92 to the smaller end 90 of the intensifier cylinder bore 86. The intensifier inlet valve 110 includes a valve seat 112, and a movable valve element of ferromagnetic material in the form of a steel ball 114 configured for mating with the valve seat 112. A retaining device, in the form of a cage 116 and a ball return spring 118, are provided for urging the ball 114 to move toward a seated position on the valve seat 112, as shown in FIG. 6a.

The valve seat 112 is formed by an orifice plug 120, that is inserted into an inlet valve cavity 122 of the actuator housing 84b, and sealed to the valve cavity 122, to form both an inlet plenum 124 for the intensifier inlet valve 110, and an outlet plenum 126 that is connected through a first intensifier inlet passage 128 in the housing 84b to the larger end 88 of the intensifier cylinder bore 86. The inlet plenum 124 is connected to the intensifier inlet 78, and houses the ball 114, the ball return spring 118, and the cage 116 of the intensifier inlet valve 110.

The inlet plenum 124 of the inlet valve 110 is further connected, via a second intensifier inlet passage 130 in the housing 84b, as shown in FIG. 5, to the internal bypass passage 92 in the intensifier actuator housing 84b. The intensifier inlet passage 130 remains open at all times, regardless of whether or not the ball 114 is seated on the valve seat 112. When the ball 114 is seated on the valve seat 112, as shown in FIG. 6a, the inlet valve 110 blocks flow from the inlet plenum 124 into the larger end 88 of the intensifier cylinder bore 86. When the ball 114 is not seated on the valve seat 112, the inlet valve 110 allows fluid to flow between inlet plenum 124 and the larger end 88 of the intensifier cylinder bore 86.

As shown, in FIGS. 6a and 6b, the vacuum powered actuator 76 includes a movable actuator element thereof, in the form of an actuator piston 132 disposed within and slidingly sealed to the wall of a vacuum cylinder bore, in the form of actuator piston bore 134.

The actuator piston bore 134 is connected at an upper end thereof, as depicted in FIGS. 6a-6b, to a vacuum port 136, and at a lower end thereof to atmospheric pressure by an actuator piston bore vent 140. The actuator piston bore 134 is separated from the inlet plenum 124 of the inlet valve 110, by an imperforate wall 142 of the actuator housing 84, that is located in close proximity to the ball 114 of the inlet valve 110. The wall 142 is fabricated from a non-magnetic material, such as aluminum, plastic, non-magnetic steel, composite or brass. In the exemplary embodiment, the entire actuator housing 84b is fabricated from a non-magnetic material, but in other embodiments of our invention the wall 142 can be provided by a separated structure of non-magnetic material inserted into an actuator housing 84b fabricated at least partially from a magnetic material.

The actuator piston 132 separates the actuator piston bore 134 into a vacuum chamber 144 connected to the vacuum port 136, and a vented atmospheric pressure chamber 146 connected to the actuator piston bore vent 140. An actuator piston return spring 148 is disposed within the vacuum chamber 144 between the housing 84b and the actuator piston 132, for urging the actuator piston 132 to move toward the actuator piston bore vent 140 and the wall 142.

A magnet 150 is attached to the actuator piston 132, for lifting the ball 114 off of the valve seat 112 when the actuator piston 132 is positioned in close proximity to the ball 114 of the intensifier inlet valve 110. In the embodiments of FIGS. 3, 6a, and 6b, the magnet 150 is attached to the actuator piston 132 by a stem 152 that is press fitted into a bore 154 in the actuator piston 132, and extends beyond the actuator piston 132 into a blind bore 156, having a diameter smaller than the actuator piston bore 134, extending from the atmospheric pressure chamber 146 toward the inlet plenum 124 of the inlet valve 110, and closed at a lower end thereof by the wall 142 of non-magnetic material. Mounting the magnet 150 on the stem 152 allows the position of the magnet 150 to be adjusted relative to the actuator piston 132 and ball 114, so that sufficient magnetic force will be available for lifting ball 114 off of the valve seat 112, when there is no vacuum applied to the vacuum port 136 and the actuator return spring 148 has moved the actuator piston to the vented end of the actuator piston bore 134.

As shown in FIG. 3, the actuator piston 132 of the exemplary embodiment also includes a second magnet 158, for actuating a magnetic switch 160 connected to the latching annunciation device 82. The magnetic switch 160 may take a number of forms, such as a mechanical reed switch or a Hall effect device. An anti-rotation pin 162 extending from the actuator housing 84b engages a bore 164 in the actuator piston 132 for keeping the second magnet rotationally aligned with the magnetic switch 160. Other embodiments of our invention may use different types of anti-rotation devices 162, 164 or magnetic switches 160.

As shown, in FIG. 4, the hydraulic pressure intensifier 74 further includes a mechanically actuated outlet valve apparatus 166, described in more detail below, for controlling the flow of hydraulic fluid through the intensifier internal bypass passage 92 between the intensifier inlet 78 and the intensifier outlet 80. During those periods of operation when the vacuum powered actuator 76 is controlling the intensifier apparatus 72 to provide hydraulic fluid to the intensifier outlet 80 at the boosted master cylinder pressure the check valve 166 is inactive, and allows fluid to flow freely in either direction between the intensifier inlet and outlet 78, 80. During those periods of operation when the vacuum powered actuator 76 is controlling the intensifier to provide hydraulic fluid to the intensifier outlet 80 at the intensified pressure during un-boosted brake operation, the mechanically actuated outlet valve apparatus 166 blocks the flow of hydraulic fluid in either direction between the intensifier inlet and outlet 78, 80. Should the pressure at the intensifier outlet 80 drop below the pressure at the intensifier inlet 78, however, during those periods of operation when the vacuum powered actuator 76 is controlling the intensifier to provide hydraulic fluid to the intensifier outlet 80 at the intensified pressure during un-boosted brake operation, the mechanically actuated outlet valve apparatus 166 will open and allow hydraulic fluid to flow through the intensifier 74 from the intensifier inlet and outlet 78, 80.

In the embodiments shown in FIGS. 3, 4, and 5, the smaller end 98 of the intensifier piston 94 includes a reduced diameter section 168, that in conjunction with the second and third piston seals 102, 104 forms an annular shaped fluid plenum 170 between the reduced diameter section 168 of the intensifier piston 94 and the smaller end 90 of the intensifier cylinder bore 86. The axial length of the reduced diameter section 168, and the axial location at which the internal bypass passage 92 enters the smaller end 90 of the intensifier cylinder bore 86 are established in such a manner that the internal bypass passage 92 is connected in fluid communication with the annular fluid plenum 170, regardless of the axial position of the intensifier piston 94 within the intensifier cylinder bore 86.

The smaller end 98 of the intensifier piston 94 also includes a cross-drilled bore 172 extending through the reduced diameter section 168 of the intensifier piston 94, in fluid communication with the annular plenum 170. A blind bore 174 extends axially into the smaller end 98 of the intensifier piston 94, and intersects with the cross-drilled bore 172 to provide fluid communication between the annular plenum 170 and the remainder of the smaller end 90 of the intensifier cylinder bore 86.

From the description above, it will be understood that the intensifier piston return spring 106 urges the intensifier piston 94 toward a first position in the intensifier cylinder bore 86, as shown in FIGS. 3, 4, and 5, when the vacuum powered actuator 76 is controlling the hydraulic pressure intensifier 74 to provide hydraulic fluid to the intensifier outlet 80 at the first (master cylinder) hydraulic pressure. When the vacuum powered actuator 76 opens the inlet valve 110, and allows fluid at master cylinder pressure to flow into the larger end 88 of the intensifier cylinder bore 86, the intensifier piston 94 moves axially away from the first position, and toward the intensifier outlet 80 at the smaller end 90 of the intensifier cylinder bore 86.

The mechanically actuated outlet valve apparatus 166 also includes a poppet 176 that is open to allow fluid flow through the outlet valve apparatus 166 when the intensifier piston 94 is in the first position, and is closed by contact with the smaller end 98 of the intensifier piston 94 when the piston 94 has moved a predetermined distance from the first position of the intensifier piston 94, toward the smaller end 90 of the intensifier cylinder bore 86.

The poppet 176 includes a resilient face seal 178, of rubber or an elastomer, that seals against the end of the intensifier piston 94 around the opening of the blind bore 174, for blocking the flow of fluid through the intensifier internal bypass passage 92 between the smaller end 88 of the intensifier cylinder bore 86 and the inlet plenum 124 of the inlet valve 110.

The mechanically actuated outlet valve 166 includes a stem 180 that extends axially from the poppet 176 and terminates at a distal end of the stem 180 in an enlarger head 182. The stem 180 extends through a hole in the end of a poppet stop sleeve 184, attached to the intensifier housing 84a adjacent the intensifier outlet 80. A poppet return spring 186 disposed between the poppet 176 and the housing 84b urges the poppet 176 to move away from the poppet stop sleeve 184 and toward the intensifier piston 94.

The enlarged head 182 at the distal end of the stem 180 resists the force of the spring 186 when the head 182 is in contact with the end of the poppet stop sleeve 184 and, together with the length of the stem 180, positions the poppet 176 in such a manner that, when the intensifier piston 94 is in the first position, the face seal 178 on the poppet 176 is spaced a predetermined distance from the end of the intensifier piston 94. As the intensifier piston 94 moves toward the smaller end 90 of the intensifier cylinder bore 86, the end of the intensifier piston 94 comes into sealing contact with the face seal 178 on the poppet 176. Once the end of the piston 94 contacts the face seal 178, the face seal 178 blocks flow through the blind bore 174 in the intensifier piston 94. As the piston 94 moves farther into the smaller end 90 of the intensifier cylinder bore 86, the stem 180 slides into the poppet stop sleeve 184 and the poppet return spring 186 is compressed.

The poppet return spring 186 is designed to have a spring rate and preload selected to allow the poppet 176 to move away from the end of the intensifier piston 94 if the pressure inside of the blind bore 174 should exceed the pressure in the smaller end 90 of the intensifier-cylinder bore 86 by a predetermined amount. When the poppet 176 moves away from the end of the piston 94, fluid can flow from the intensifier inlet 78 to the intensifier outlet 80 through the fluid path formed by the bypass passage 92, the annular shaped fluid plenum 170, the cross drilled bore 172 and the blind bore in the intensifier piston 94, and the smaller end 90 of the intensifier cylinder bore 86.

With an intensifier apparatus 72, as described above, connected as shown in FIG. 3, operation of the braking system 70 is as follows.

When a vacuum is present for operating the vacuum booster 26, the vacuum applied at the vacuum port 136 evacuates the vacuum chamber 144, and air pressure entering the atmospheric pressure chamber 146 through the vent 140 of the actuator piston bore 134 pushes the actuator piston away from the ball 114 of the inlet valve 110. Movement of the piston away from the ball 114 results in the magnet 150 on the actuator piston 132 being moved out of close proximity with the ball 114 of the inlet valve 110. The ball return spring 118 pushes the ball 114 into seated engagement with the valve seat 112, as shown in FIG. 6a, to thereby block fluid from flowing from the intensifier inlet 78 to the larger end 88 of the intensifier cylinder bore 86. As the driver depresses and releases the brake pedal 20, fluid from the master cylinder 24 at a boosted pressure, from the action of the vacuum booster 26, can flow through the intensifier internal bypass passage 92 and the mechanically actuated outlet valve apparatus 166, to and from the wheel cylinders 44, 46 for operating the brakes. In this operational mode, the hydraulic intensifier 74 is essentially inactive.

When a vacuum is not present for operating the vacuum booster 26, the absence of vacuum at the vacuum port 136 results in the actuator return spring 148 moving the magnet 150 on the actuator piston 132 into close proximity with the ball 114 of the inlet valve 110. With the magnet in close proximity to the ball 114, the magnetic force acting on the ball 114 through the wall 142 overcomes the force of the ball return spring 118, and pulls the ball 114 out of seated engagement with the valve seat 112, as shown in FIG. 6b, to thereby allow fluid to flow from the intensifier inlet 78 to the larger end 88 of the intensifier cylinder bore 86.

As the driver depresses the brake pedal 20, fluid from the master cylinder 24 at an un-boosted pressure is applied to the larger end 96 of the intensifier piston 94. The un-boosted pressure acting on the larger end 96 of the intensifier piston 94 causes the intensifier piston 94 to move in the intensifier cylinder bore 86 toward the smaller end 90 of the intensifier cylinder bore 86. When the intensifier piston 94 has moved a short distance, it contacts the face seal 178 on the poppet 176 of the outlet valve apparatus 166, thereby blocking any further fluid flow through the internal bypass passage 92. With the bypass passage 92 blocked, the un-boosted pressure acting on the larger end of the intensifier piston 94 causes the fluid pressure at the intensifier outlet 80 to be increased in proportion to the area ratio between the larger and smaller ends 96, 98, so that braking force is maintained at the wheel cylinders 44, 46.

When the driver partially reduces or completely removes the force that he is exerting on the pedal 20, the process is reversed, to allow fluid in the wheel cylinders 44, 46 to flow back into the smaller end 90 of the intensifier cylinder bore 86, and fluid in the larger end 88 of the intensifier cylinder bore 86 to flow back to the master cylinder 26. As braking pressure is reduced, the intensifier piston return spring 106 pushes the intensifier piston 94 back toward the first position. Shortly before the intensifier piston 94 reaches the first position, the head 182 on the stem 180 extending from the poppet 176 contacts the end of the poppet stop sleeve 184, and the end of the intensifier piston 94 is pushed out of contact with the poppet 176 by the intensifier piston return spring 106. As the end of the intensifier piston 94 moves out of contact with the poppet 176, the mechanically actuated outlet valve apparatus 166 opens and allows fluid in the smaller end 90 of the intensifier cylinder bore 86 to flow back to the master cylinder 26 via the blind bore 174 and the cross drilled bore 172 in the smaller end 98 of the intensifier piston 94, the annular shaper plenum 170 and the internal bypass passage 92 of the intensifier 74.

In the event that the pressure at the intensifier outlet 80 should be lower than the pressure at the intensifier inlet 78, while the poppet 176 is blocking the blind bore 174 in the smaller end 98 of the intensifier piston 94, the force generated by the pressure inside the blind bore, acting against the poppet 176, will generate a force acting on the poppet 176 that is great enough to overcome the force of the poppet return spring 186, and cause the poppet to move away from the smaller end 98 of the intensifier piston 94. With the poppet 176 moved away from the smaller end 98 of the intensifier piston, the blind bore 174 will be open to allow fluid to flow through the internal bypass passage 92 from the intensifier inlet 78 to the intensifier outlet 80.

The pressure at the intensifier outlet 80 can be lower than the pressure at the intensifier inlet 78, during brake operation with either the vacuum booster 26 or the hydraulic intensifier apparatus 72, if there is air in the smaller end 90 of the intensifier cylinder bore 86, the wheel cylinders 44, 46 attached to the intensifier 72, or in the brake circuit 40 between the intensifier 72 and the wheel cylinders 44, 46. Such a condition can occur during operations such as bleeding the brake circuit 40 to completely fill the circuit 40 with fluid. The mechanically actuated outlet valve apparatus 166 of our invention thus provides a convenient means of automatically overriding the flow-blocking function of the poppet 176, should it be necessary to do so.

In addition to controlling fluid flow through the intensifier 74 in the manner described above, when vacuum is absent at the vacuum port 136, the actuator piston return spring 148 also moves the second magnet 158 on the actuator piston 132 into proximity of the magnetic switch 160, and causes the second magnet 158 to actuate the magnet switch 160. A signal from the magnetic switch 160 causes the latching annunciation device 82 to report that the brake system 70 is operating without the aid of vacuum boost, and that the hydraulic intensifier apparatus 72 is active.

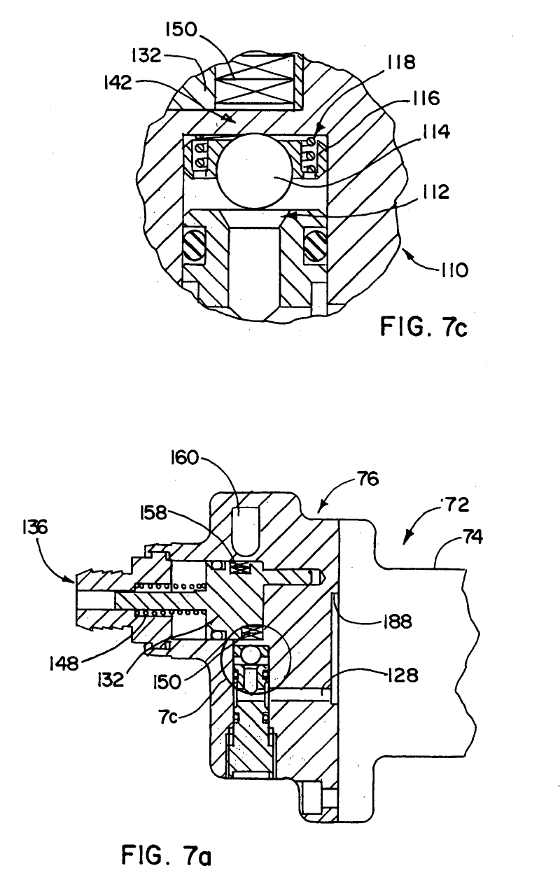

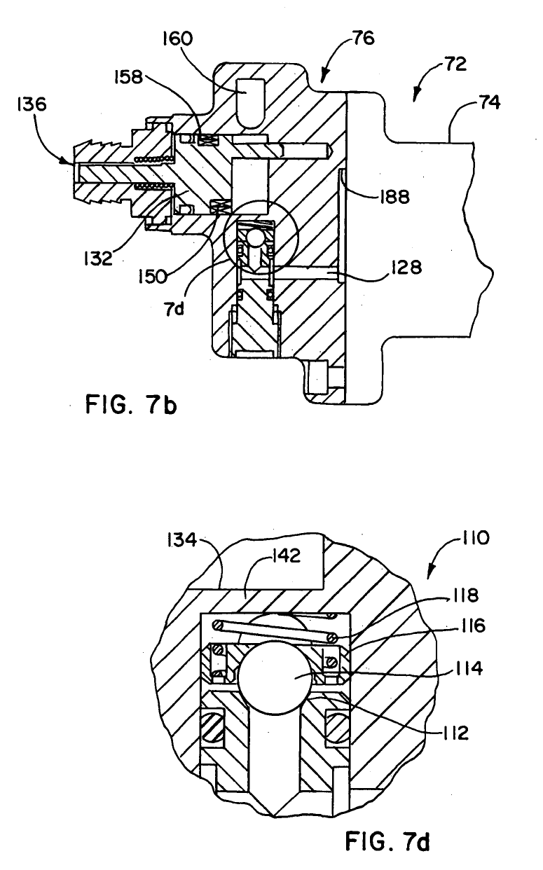

Those skilled in the art will readily recognize that, while the embodiments of our invention disclosed herein are presently considered to be preferred, various changes and modifications can be made without departing from the spirit and scope of the invention. For example, FIGS. 7a through 7d show an alternate embodiment of a vacuum powered actuator 76, according to our invention, where the actuator piston 132 moves perpendicular to the direction of movement of the ball 114 of the intensifier valve, rather than moving generally parallel to direction of movement of the ball 114 in the embodiments described in conjunction with FIGS. 3, 6a and 6b.

Several of the components in FIGS. 7a-7d are marked with the same reference numbers used above in describing the embodiments of FIGS. 3, 6a and 6b to facilitate understanding of the alternate embodiment, but the description of structure and operation of the alternate embodiment is not repeated here, because the structure and operation of this embodiment of our invention are similar enough to the embodiments described above that the alternate embodiment can be readily understood by those skilled in the art from comparing FIGS. 7a through 7d to FIGS. 3, 6a and 6b together with the description above.

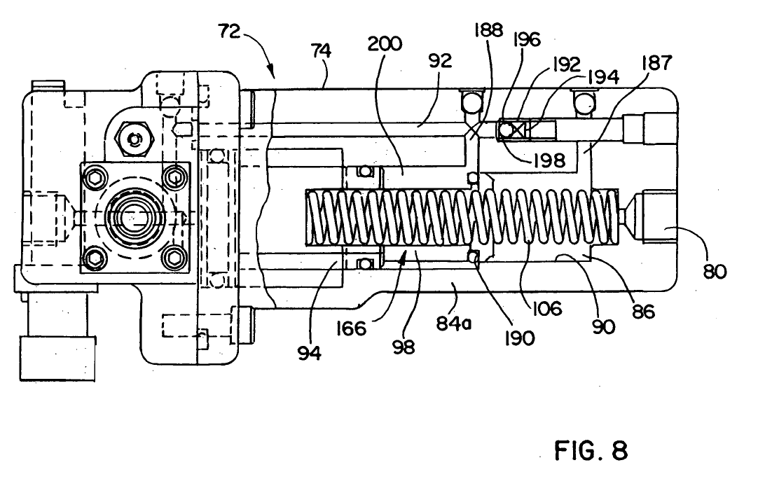

FIG. 8 shows an alternate embodiment of a hydraulic intensifier apparatus 72, according to our invention, having an intensifier internal bypass passage 92 that extends through the intensifier housing 84a completely past the smaller end 98 of the piston 94 to and connecting with the smaller end 90 of the intensifier cylinder bore 86, through a first bypass port 187 located near the intensifier outlet 80. The bypass passage 92 also includes a second bypass port 188 connecting with the smaller end 90 of the intensifier cylinder bore 86 at a point spaced a short distance away from the smaller end 98 of the intensifier piston 94, toward the intensifier outlet 80, when the intensifier piston return spring 106 is holding the intensifier piston 94 in a first position at a maximum distance from the intensifier outlet 80, as shown in FIG. 8.

When the intensifier piston 94 is in the first position, the second bypass port is un-blocked, and allows fluid to flow through the second bypass port and the internal bypass passage 92, between the intensifier inlet and outlet 78, 80. When the vacuum operated actuator 76 causes the larger end 88 of the intensifier cylinder bore 86 to begin to fill with fluid, thereby forcing the intensifier piston 94 to move toward the intensifier outlet 80, a seal 190 on the smaller end 98 of the intensifier piston 94 closes off the second bypass port 188.

The mechanically actuated outlet valve apparatus 166 of the second exemplary embodiment shown in FIG. 8 also includes a spring operated, ball-and-seat type, check/relief valve 192 disposed in the bypass passage 92 between the first and second bypass ports 187, 188. The check/relief valve 192 includes a ball 196 that is held in a normally closed position on a check/relief valve seat 196, by a check/relief valve spring 194.

The check/relief valve 192 blocks flow from entering the bypass passage 92 through the first bypass port 187, so long as the pressure at the first bypass port 187 is greater than or equal to the pressure at the second bypass port 188. If the pressure at the second bypass port 188 exceeds the pressure at the first bypass port 187 by an amount great enough to overcome the force of the spring 194 of the check/relief valve 192, the ball 196 of the check/relief valve 192 lifts off of the seat 198 of the check/relief valve 192, so that fluid can flow through the bypass passage 92 and the first bypass port 187 from the intensifier inlet 78 to the intensifier outlet 80.

To facilitate flow through the intensifier 74 when the second bypass port 188 is not blocked, the intensifier cylinder bore 86 of the exemplary embodiment shown in FIG. 8 includes an intermediate diameter section 200 of the stepped intensifier cylinder bore 86, that has a diameter smaller than the larger end 88 and larger than the smaller end 90 of the intensifier cylinder bore 86, and extends just beyond the end of the intensifier piston 94 when the intensifier piston is in a first position, as shown in FIG. 8. Flow through the second bypass port 188 is cut off whenever the intensifier piston 94 has moved far enough from the first position for the seal 190 on the smaller end 98 of the intensifier piston 94 for the seal 190 to enter into and seal against the wall of the smaller end 90 of the intensifier cylinder bore.

The scope of the invention is indicated in the appended claims, and all changes or modifications within the meaning and range of equivalents are intended to be embraced therein.

1. A hydraulic pressure intensifier apparatus, comprising:
a hydraulic pressure intensifier defining a circuit for hydraulic fluid having an intensifier inlet for receiving hydraulic fluid at a first pressure and an intensifier outlet for selectively delivering hydraulic pressure at either the first hydraulic pressure or a second pressure higher than the first hydraulic pressure; and
a vacuum powered actuator for selectively controlling the hydraulic pressure intensifier to provide hydraulic fluid at the intensifier outlet at the first or the second hydraulic pressure.

2. The hydraulic pressure intensifier apparatus of claim 1, further comprising a vacuum circuit therein, completely separated from the circuit for hydraulic fluid

3. The hydraulic pressure intensifier apparatus of claim 1 further comprising a mechanically actuated outlet valve apparatus for allowing a flow of hydraulic fluid between the intensifier inlet and the intensifier outlet when the vacuum powered actuator is controlling the intensifier to provide hydraulic fluid to the intensifier outlet at the first pressure, and for blocking a flow of hydraulic fluid between the intensifier inlet and outlet when the vacuum powered actuator is controlling the intensifier to provide hydraulic fluid to the intensifier outlet at the second pressure.

4. The hydraulic pressure intensifier apparatus of claim 3 wherein the outlet valve apparatus further allows a flow of hydraulic fluid from the intensifier inlet and intensifier outlet when the pressure at the intensifier outlet is less than the pressure at the intensifier inlet while the vacuum powered actuator is controlling the intensifier to provide hydraulic fluid to the intensifier outlet at the second pressure.

5. The hydraulic pressure intensifier apparatus of claim 1 including a latching annunciation element for detecting when the vacuum powered actuator is controlling the hydraulic pressure intensifier for supplying fluid at the second pressure.

6. The hydraulic pressure intensifier apparatus of claim 1 wherein the hydraulic pressure intensifier includes an intensifier movable wall having a larger surface thereof connectable in fluid communication with the intensifier inlet and a smaller surface thereof connected in fluid communication with the intensifier outlet.

7. The hydraulic pressure intensifier apparatus of claim 6, further comprising:
an intensifier internal fluid bypass passage providing fluid communication between the intensifier inlet and the smaller surface of the intensifier movable wall; and
an intensifier inlet valve operatively actuated by the vacuum powered actuator for selectively directing hydraulic fluid from the intensifier inlet to either the larger surface of the intensifier movable wall, or alternatively through the intensifier internal bypass passage to the smaller surface of the intensifier movable wall.

8. The hydraulic pressure intensifier apparatus of claim 1, comprising:
a housing defining the intensifier inlet and outlet, and a stepped intensifier cylinder bore having a larger end and a smaller end, with the intensifier inlet connected in fluid communication with the larger end of the intensifier cylinder bore and the intensifier outlet connected in fluid communication with the smaller end of the intensifier cylinder bore, the housing further defining an intensifier internal fluid bypass passage providing fluid communication between the intensifier inlet and the smaller end of the intensifier cylinder bore; and
an intensifier inlet valve operatively actuated by the vacuum powered actuator for selectively directing hydraulic fluid from the intensifier inlet to either the larger end of the intensifier cylinder bore, or through the intensifier internal bypass passage to the smaller end of the intensifier cylinder bore.

9. The hydraulic pressure intensifier apparatus of claim 8, further comprising:
an intensifier piston having a larger and a smaller end thereof, the larger end thereof disposed within and slidingly sealed to the larger end of the intensifier cylinder bore, and the smaller end thereof disposed within and slidingly sealed to the smaller end of the cylinder bore; and
an intensifier piston return spring disposed between the piston and the housing for urging the piston to move within the intensifier cylinder bore toward the larger end of the intensifier cylinder bore.

10. The hydraulic pressure intensifier apparatus of claim 9 further comprising a mechanically actuated outlet valve apparatus for allowing a flow of hydraulic fluid between the intensifier inlet and the intensifier outlet when the vacuum powered actuator is controlling the intensifier to provide hydraulic fluid to the intensifier outlet at the first pressure, and for blocking a flow of hydraulic fluid between the intensifier inlet and outlet when the vacuum powered actuator is controlling the intensifier to provide hydraulic fluid to the intensifier outlet at the second pressure.

11. The hydraulic pressure intensifier apparatus of claim 10 wherein the outlet valve apparatus further allows a flow of hydraulic fluid between the intensifier inlet and intensifier outlet when the pressure at the intensifier outlet is less than the pressure at the intensifier inlet while the vacuum powered actuator is controlling the intensifier to provide hydraulic fluid to the intensifier outlet at the second pressure.

12. The hydraulic pressure intensifier apparatus of claim 10, wherein:
the intensifier piston return spring urges the piston toward a first position in the intensifier cylinder bore when the vacuum powered actuator is controlling the hydraulic pressure intensifier to provide hydraulic fluid at the intensifier outlet at the first hydraulic pressure;
the mechanically actuated outlet valve apparatus includes a poppet that is open to allow fluid flow through the outlet valve apparatus when the intensifier piston is in the first position, and is closed by contact with the small end of the intensifier piston when the piston has moved a predetermined distance from the first position of the intensifier piston toward the small end of the cylinder bore;
the smaller end of the intensifier piston defines a bore therein operatively connected to provide a sealed fluid connection with the intensifier inlet, such that all fluid flow between the inlet and outlet of the intensifier must flow through the bore in the intensifier piston;
the poppet closes the bore in the intensifier piston when the poppet is in contact with the smaller end of the intensifier piston;
the outlet valve apparatus includes a poppet spring operatively connected between the poppet and the housing for urging the poppet toward contact with the smaller end of the intensifier piston; and
the poppet spring is compressible for allowing the poppet to move away from the smaller end of the intensifier piston when the pressure at the intensifier outlet is less than the pressure at the intensifier inlet, to thereby allow a flow of hydraulic fluid through the bore in the intensifier piston from the intensifier inlet to intensifier outlet while the vacuum powered actuator is controlling the intensifier to provide hydraulic fluid to the intensifier outlet at the second pressure.

13. The hydraulic pressure intensifier apparatus of claim 10, wherein:
the intensifier piston return spring urges the piston toward a first position in the intensifier cylinder bore when the vacuum powered actuator is controlling the hydraulic pressure intensifier to provide hydraulic fluid at the intensifier outlet at the first hydraulic pressure;
the intensifier internal bypass passage extends completely past the intensifier piston and includes a first bypass port located adjacent the intensifier outlet for providing fluid communication between the internal bypass passage and the smaller end of the intensifier cylinder bore;
the intensifier internal bypass passage also includes a second bypass port providing fluid communication between the bypass passage and the smaller end of the intensifier cylinder bore at a point spaced a predetermined distance away from the smaller end of the intensifier piston, toward the intensifier outlet, when the intensifier piston return spring is holding the intensifier piston in the first position;
the intensifier piston includes a seal affixed thereto for blocking the second bypass port when the intensifier piston has moved the predetermined distance toward the intensifier outlet; and
the mechanically operated outlet valve apparatus further comprises a spring operated check/relief valve disposed in the bypass passage between the first and second bypass ports for blocking flow from entering the bypass passage through the first bypass port, so long as the pressure at the first bypass port is greater than the pressure at the second bypass port, and for allowing flow through the bypass passage and the first bypass port from the intensifier inlet to the intensifier outlet if the pressure at the second bypass port exceeds the pressure at the first bypass port.

14. The hydraulic pressure intensifier apparatus of claim 7, wherein:
the intensifier inlet valve includes a valve seat, a movable valve element of ferromagnetic material configured for mating with the valve seat; and
the vacuum powered actuator includes a movable actuator element thereof including a magnet for lifting the movable valve element off of the valve seat when the movable actuator element is positioned in close proximity to the movable valve element of the intensifier inlet valve.

15. The hydraulic pressure intensifier apparatus of claim 14, further comprising a retaining device for urging the movable valve element to remain mated with the valve seat when the movable actuator valve element is moved out of close proximity to the movable valve element of the intensifier inlet valve.

16. The hydraulic pressure intensifier apparatus of claim 14, wherein:
the housing further defines a vacuum cylinder bore of the vacuum powered actuator having a vacuum connection port at one end thereof and a vent to atmospheric pressure at an opposite end thereof;
the movable actuator element is an actuator piston disposed within and slidingly sealed to the vacuum cylinder bore between the vacuum port and the vent to thereby separate the vacuum cylinder bore into a vacuum chamber in fluid communication with the vacuum port, and a vented chamber in fluid communication with the vent.

17. The hydraulic pressure intensifier apparatus of claim 16, wherein the vacuum cylinder bore and the intensifier inlet valve are separated from one another by an imperforate wall of non-magnetic material.

18. The hydraulic pressure intensifier apparatus of claim 16 wherein:
the hydraulic pressure intensifier further includes an actuator spring element for urging the actuator piston to move toward the vented cavity of the actuator cylinder bore and into close proximity to the movable valve element;
the movable valve element of the intensifier inlet valve is mated with the valve seat and blocks fluid flow between the intensifier inlet and the large end of the intensifier cylinder bore when a vacuum applied to the vacuum port moves the actuator piston out of close proximity to the movable valve element; and
the movable valve element is lifted off of the valve seat to allow fluid flow through the intensifier internal fluid bypass passage between the intensifier inlet and the smaller end of the intensifier cylinder bore when vacuum is removed from the vacuum port and the actuator piston is in close proximity to the movable valve element.

19. A brake apparatus comprising:
a braking device,
a master cylinder for supplying pressurized fluid at a master cylinder pressure to the braking device in response to an input force applied to the master cylinder;
a vacuum booster operatively connected to the master cylinder for augmenting the input force applied to the master cylinder to increase the master cylinder pressure supplied by the master cylinder in response to the input force; and
a hydraulic pressure intensifier apparatus, including a hydraulic pressure intensifier and a vacuum powered actuator;
the hydraulic pressure intensifier defining a circuit for hydraulic fluid having an intensifier inlet for receiving hydraulic fluid from the master cylinder at the master cylinder pressure and an intensifier outlet for selectively delivering hydraulic pressure to the braking device at either the master cylinder pressure or at an intensified pressure higher than the master cylinder pressure, and
the vacuum powered actuator selectively controlling the hydraulic pressure intensifier to provide hydraulic fluid at the intensifier outlet at the master cylinder pressure or the intensified hydraulic pressure.

20. The brake apparatus of claim 19 including a latching annunciation element for detecting when the vacuum powered actuator is controlling the hydraulic pressure intensifier for supplying fluid at the intensified pressure.

21. The brake apparatus of claim 19, wherein:
the vacuum powered actuator controls the hydraulic pressure intensifier to deliver fluid to the braking device at the master cylinder pressure when a vacuum is present at the vacuum booster; and
the vacuum powered actuator controls the hydraulic pressure intensifier to deliver fluid to the braking device at the intensified pressure when a vacuum is not present at the vacuum booster.

22. The brake apparatus of claim 21, wherein the hydraulic pressure intensifier of claim further includes a mechanically actuated outlet valve apparatus for allowing a flow of hydraulic fluid between the intensifier inlet and the intensifier outlet when the vacuum powered actuator is controlling the intensifier to provide hydraulic fluid to the intensifier outlet at the master cylinder pressure, and to block a flow of hydraulic fluid between the intensifier inlet and outlet when the vacuum powered actuator is controlling the intensifier to provide hydraulic fluid to the intensifier outlet at the intensified pressure.

23. The brake apparatus of claim 22 wherein the mechanically actuated outlet valve apparatus further allows a flow of hydraulic fluid between the intensifier inlet and intensifier outlet when the pressure at the intensifier outlet is less than the pressure at the intensifier inlet while the vacuum powered actuator is controlling the intensifier to provide hydraulic fluid to the intensifier outlet at the second pressure.

24. A method for operating a brake apparatus including a braking device, a master cylinder for supplying pressurized fluid at a master cylinder pressure to the braking device in response to an input force applied to the master cylinder, and a vacuum booster operatively connected to the master cylinder for augmenting the input force applied to the master cylinder to increase the master cylinder pressure supplied by the master cylinder in response to the input force, the method comprising:
providing a hydraulic pressure intensifier defining a circuit for hydraulic fluid having an intensifier inlet for receiving hydraulic fluid from the master cylinder at the master cylinder pressure and an intensifier outlet for selectively delivering hydraulic pressure to the braking device at either the master cylinder pressure or at an intensified pressure higher than the master cylinder pressure, and
selectively controlling the hydraulic pressure intensifier with a vacuum powered actuator to provide hydraulic fluid at the intensifier outlet at the master cylinder pressure or at the intensified hydraulic pressure.

25. The method of claim 24 further comprising allowing a flow of hydraulic fluid between the intensifier inlet and intensifier outlet when the pressure at the intensifier outlet is less than the pressure at the intensifier inlet while the vacuum powered actuator is controlling the intensifier to provide hydraulic fluid to the intensifier outlet at the intensified hydraulic pressure.
